(19) United States
(12) Patent Application Publication
(10) Pub. No.: US 2026/0251755 A1
(43) Pub. Date: Aug. 27, 2026

(54) METHOD AND SYSTEM FOR DETECTING ANOMALIES IN A RADAR SYSTEM ON BOARD OF A SHIP

(71) Applicant: E-PHORS S.P.A., Milano (IT)

(72) Inventors: Enrico RUSSO, Genova (IT); Alessandro ARMANDO, Genova (IT); Alessio MERLO, Genova (IT); Giacomo LONGO, Genova (IT)

(21) Appl. No.: 18/992,544

(22) PCT Filed: Jul. 8, 2022
(86) PCT No.: PCT/IT2022/000036

§ 371 Date: Jan. 8, 2025

(51) Int. Cl. G01S 7/40; G01S 7/00; G01S 7/06; G01S 13/937; H04L 9/40

(52) U.S. Cl. CPC G01S 7/40; G01S 7/006; G01S 7/06; G01S 13/937; H04L 63/1425

(57) ABSTRACT

A method is for detecting anomalies in a radar system on board of a ship. The presence or absence of an anomaly in the radar system is detected based on a comparison between a characterization of a received data packet provided by a shipboard collector module and an applicable selected set of reference policies stored in a database sub-module of a policy evaluation module. An information representative of an anomaly detected in the radar system is then generated.

### CROSS-REFERENCE TO RELATED APPLICATION

The present application is a National Stage Application of PCT International Application No.: PCT/IT2022/000036 filed on Jul. 8, 2022, the disclosure of which is incorporated herein by reference in its entirety.

### FIELD OF THE INVENTION

The present invention relates to the naval field, in particular to a method and system for detecting anomalies in a radar system on board of a ship.

### TECHNOLOGICAL BACKGROUND

The operation of a ship increasingly relies on information and telecommunication technologies (ICT) and operational technologies (OT) present shipboard.

Said technologies achieve automation of shipboard operations associated with mechanical and electrical subsystems, guaranteeing significant cost reductions while, at the same time, increasing safety shipboard because they provide valuable support for planning, control, and monitoring the navigation as well as performing tasks that would be risky if performed by the crew.

As a result of faster and faster technological evolution and adaptation due to stringent regulations in the maritime field, also at the international level, significant digitization of shipboard systems is occurring.

In this regard, the so-called Integrated Navigation System (INS) is definitely at the center of this digitization.

Typically, the integrated navigation system collects information and, by integrating functions from a variety of electronic shipboard devices (e.g., radar), supports shipboard operators to plan, monitor, and control navigation by helping to improve the awareness of the overall situation.

It is apparent that radar plays a key role during navigation in forming the crew's situational awareness, thus allowing the crew to best deal with the situations encountered by the ship and the decision-making process to avoid collisions.

Indeed, the radar can automatically detect and calculate the trajectories of other ships.

Typically, a radar is integrated with various components of the integrated navigation system by means of the support of a data communication network which exploits standard network protocols, e.g., such as NMEA and ASTERIX CAT-240, where the NMEA protocol enables interaction between all devices in the integrated navigation system, while the ASTERIX CAT-240 protocol enables the transmission of video data between radar antennas and shipboard displays.

Although the use of these technologies helps improve the safety and efficiency of navigation, the digitization of a ship inevitably exposes it to cybersecurity threats.

This is certainly a non-negligible drawback because although the overall number of cyber-attacks is relatively small compared to other sectors and although successfully launching a cyber-attack against a ship is not easy (an integrated navigation system is generally offline and breaching it through lateral movements from other networks by controlling an attack from the Internet may not be an option; moreover, both the individual components and the configuration of the integrated navigation system may vary from ship to ship), the risk of a cyber-attack remains, and considering that the impact of a cyber-attack, especially in the maritime sector, could also lead to very serious events (e.g., loss of life, environment, or economy), the problem of cyber-attacks should definitely not be underestimated.

A cyber-attack can have a variety of objectives ranging from “merely” disrupting operations to inflicting heavy economic losses or the payment of a ransom to deliberately attempting to cause a collision.

Since a crew makes decisions by cross-checking multiple systems shipboard, it is critical that the information reported by instrumentation is available and not altered by a cyber-attack.

In this regard, the security of standard communication protocols, such as NMEA and ASTERIX, assumes that the data communication network and interconnected subsystems are reliable, and therefore no provision is made regarding additional protection mechanisms to ensure the integrity and availability of exchanged information.

Even worse, due to the average lifespan of modern ships (up to 40 years) and the fact that retrofitting an integrated navigation system is costly and time-consuming, the aforementioned limitations in terms of cybersecurity are most often destined to accompany the ship throughout its entire operational period.

In light of the above, the need is strongly felt for a method for detecting anomalies in a radar system on board of a ship due to a cyber-attack or caused by malfunctions in the radar system (e.g., mechanical failure of the engine or other radar system components) so that it can ensure detection of a cyber-attack in the most effective, timely, and reliable manner possible and can be implemented aboard the ship while minimizing the impact, both in terms of installation time and cost, on the integrated navigation system and generally on the existing configuration of the ship itself.

### SUMMARY

It is the purpose of the present invention to devise and make available a method for detecting anomalies in a radar system on board of a ship due to a cyber-attack or caused by malfunctions in the radar system, which allows at least partially solving the drawbacks highlighted above with reference to the prior art, in particular, that allows guaranteeing the detection of a cyber-attack in the most effective, timely and reliable manner and that can be implemented shipboard while minimizing the impact, both in terms of installation time and cost, on the integrated navigation system and in general on the existing configuration of the ship itself, not even requiring specific interventions or modifications such as to invalidate previous certifications and/or standardizations that would then be required at that point.

Such a purpose is achieved by a method for detecting anomalies in a radar system on board a of ship, comprising steps of: receiving, by a shipboard collector module, from a shipboard data communication network with the support of a set video data transmission protocol, a stream of data packets coming from a plurality of radar antenna units distributed shipboard and configured to transmit data on said data communication network, each data packet originating from a radar antenna unit of said plurality of radar antenna units, and comprising an identification code and technical values representative of the radar antenna unit of said plurality of antennas from which said data packet originates; analyzing, by an analyzer sub-module of the shipboard collector module, each received data packet to extract the identification code and said technical values representative of the radar antenna unit of said plurality of antennas from which said data packet originates and providing said identification code and said technical values representative of the radar antenna unit to a memory buffer of an aggregator sub-module of the shipboard collector module; determining, by the aggregator sub-module of the shipboard collector module, aggregate information of the received data packet based on the identification code and technical values representative of the radar antenna unit extracted from the received data packet and based on additional technical values representative of the radar antenna unit of said plurality of radar antenna units identified by the same identification code and previously stored in the memory buffer of the aggregator sub-module of the shipboard collector module; determining, by the analyzer sub-module of the shipboard collector module, for each received data packet, a characterization of said received data packet comprising the identification code and the technical values representative of the radar antenna unit extracted from the received data packet, the aggregate information determined by the aggregator sub-module and an aggregate information time series associated with said radar antenna unit; storing, by the analyzer sub-module of the shipboard collector module, the determined characterization of the received data packet in a first database sub-module of the shipboard collector module, said aggregate information time series contained in the characterization of the received data packet being determined, by a historical sub-module of the shipboard collector module, based on aggregate information time series previously stored in the first database sub-module of the shipboard collector module and associated with previously received data packets referring to the same radar antenna unit of said plurality of radio antenna units; providing, by the shipboard collector module, the determined characterization of the received data packet to a policy evaluation module; providing, by the shipboard collector module, a last characterization determined for each received data packet referred to a radar antenna unit of said plurality of radar antenna units other than the radar antenna unit from which the received data packet originates, to a policy generator module; selecting, by the policy generator module, set reference policies applicable based on the last characterization determined for each received data packet referred to a radar antenna unit of said plurality of radar antenna units other than the radar antenna unit from which the received data packet originates provided by the shipboard collector module, said applicable set reference policies being selected from a plurality of candidate set reference policies stored in a second database of the policy generator module, each reference policy comprising set rules representative of the expected conditions of the radar system when operating correctly; providing, by the policy generator module, said selected applicable set reference policies to a third database sub-module of said policy evaluation module; detecting, by the policy evaluation module, the presence or absence of an anomaly in the radar system based on the comparison between the characterization of the received data packet provided by the shipboard collector module and the selected applicable set reference policies stored in the third database sub-module of said policy evaluation module; generating, by the policy evaluation module, information representative of an anomaly detected in the radar system.

A related object of the present invention is a related system for detecting anomalies in a radar system on board of a ship.

### BRIEF DESCRIPTION OF THE DRAWINGS

Further features and advantages of the system and the method thereof according to the invention will be apparent from the following description which illustrates preferred embodiments, given by way of indicative, non-limiting examples, with reference to the accompanying figures, in which:

FIG. 1 diagrammatically shows an example of a ship on which a system and method thereof for detecting anomalies in a radar system on board of a ship according to the present invention can be used;

FIG. 2a shows, by means of a block diagram, a topology of a data communication network on board of a ship to which additional components installed aboard the ship are connected;

FIG. 2b diagrammatically shows a display unit of a radar system in which the system according to the present invention can be implemented;

FIG. 3 shows, by means of a block diagram, a system for detecting anomalies in a radar system on board of a ship, according to an embodiment of the invention;

FIG. 4 diagrammatically shows a component of the system in FIG. 3, according to an embodiment of the invention;

FIG. 5 shows, by means of a block diagram, a method for detecting anomalies in a radar system on board of a ship according to an embodiment of the invention.

### DETAILED DESCRIPTION

With reference to the aforementioned figures, reference numeral 100 as a whole indicates a system for detecting anomalies in a radar system on board of a ship, hereinafter also named only detection system or simply system, according to the invention.

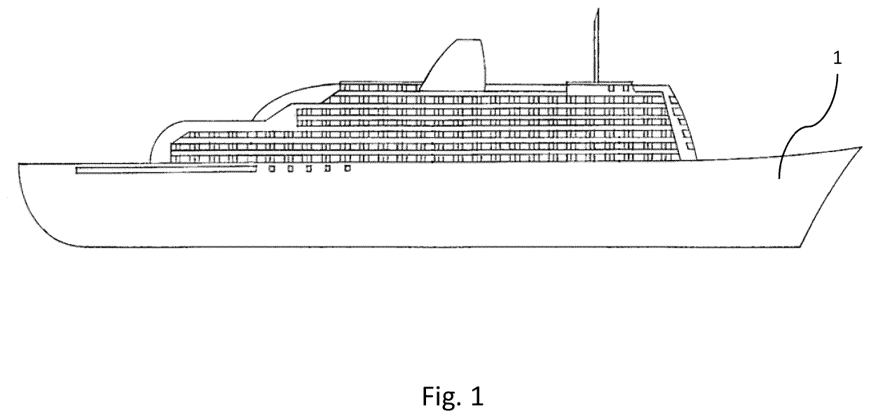

An example of a ship, indicated by reference numeral 1 as a whole, is shown in FIG. 1.

For the purpose of the present description, ship means any vessel usable for cruises, recreational and tourist service, e.g. a cruise ship, as shown in FIG. 1, or any other ship, e.g. such as ships usable in the military sector, merchant ships, work ships, and so on.

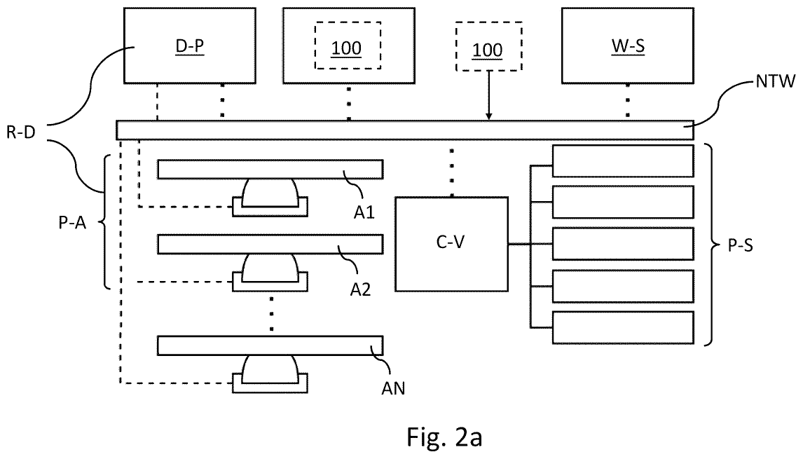

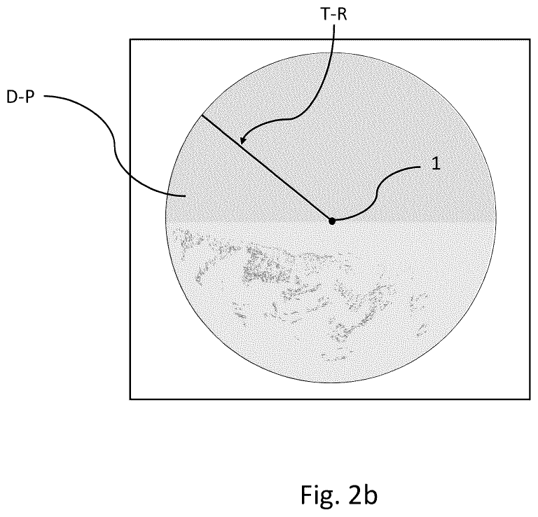

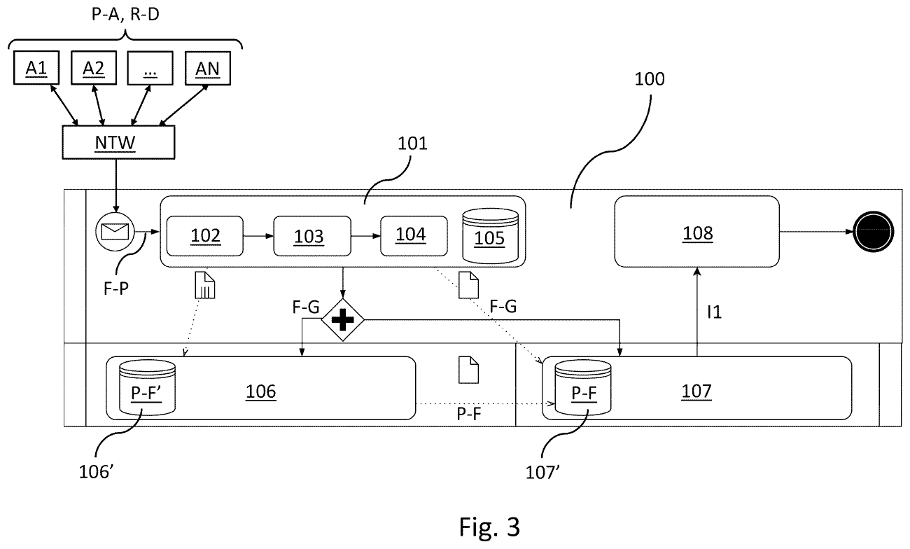

Referring specifically to FIGS. 2a and 3, the system 100 is an electronic system installed shipboard.

In greater detail, the system 100 is operationally connected to a shipboard data communication network NTW.

An example of a data communication network NTW is diagrammatically shown in FIG. 2a.

The data communication network NTW, e.g., an Ethernet network, is the so-called navigation network.

In a ship, a plurality of sensors P-S installed shipboard is operationally connected to the data communication network NTW and provide respective sensed data to the navigation network.

In this regard, the plurality of the sensors P-S is operationally connected to the data communication network NTW by means of a converter C-V, e.g., an analog-to-digital converter (ADC), capable of collecting the data collected from each sensor of the plurality of sensors P-A and forwarding it to the data communication network NTW in a format which conforms to a set transmission protocol provided by the data communication network NTW.

Examples of sensors belonging to the plurality of sensors P-S are an Electronic Position Fixing System (EPFS), a Speed and Distance Position Equipment (SDME), a compass, a gyroscope, a transponder for a standard data communication system between a ship and other maritime authorities, such as the Automatic Identification System (AIS).

In a ship, a radar system R-D, a main computer C-P and a plurality of workstations W-S available to shipboard personnel are also operationally connected to the navigation network.

The radar system R-D comprises a plurality of radar antenna units P-A and at least one display unit D-P.

Each radar antenna unit, also indicated in the figures by references A1, A2, . . . , AN, of said plurality of radar antenna units P-A is configured to detect objects around the ship by the use of radio waves.

In this regard, each radar antenna unit is adapted to radiate radio waves and receive return echo radio waves from objects around the ship.

According to the type, a radar antenna unit can be rotating, e.g., adapted to rotate by 360° about a respective rotation axis, or be non-rotating.

Each radar antenna unit is adapted to transmit the return echo radio waves to the at least one display unit D-P on the data communication network NTW by means of a set video data transmission protocol, e.g. a proprietary protocol, ASTERIX protocol, and so on.

Referring now also to FIG. 2b, the at least one display unit D-P, also named Plan Position Indicator (PPI), is a circular display representative of a radar antenna unit, wherein the ship is shown in the center, always indicated by numerical reference 1.

A radial track T-R runs in unison with the radar antenna unit about the center. Each radial track represents radio waves of return echo at a planar position with detection and distance displayed in planar coordinates.

The at least one display unit D-P is preferably installed in the shipboard dashboard.

For example, the main computer C-P is a specialized digital navigation computer, named Electronic Chart Display and Information System (ECDIS), which is a real-time, i.e., simultaneous, electronic navigation system configured to display and manage map information (such as geographic coordinates or depth levels) on a display.

Referring again to FIG. 2a, the data communication network NTW (data navigation network) and the components operationally connected to it are representative of the so-called Integrated Navigation System (INS) which is present on a ship.

The system 100 object of the present invention is operationally connected to the data communication network NTW.

Therefore, the system 100 is operationally connected to the data communication network NTW, thus, on the one hand, to the plurality of radar antenna units P-A of the radar system R-D and, on the other hand, to the at least one display unit D-P of the radar system R-D.

In an embodiment, shown with dotted lines in FIG. 2a, the system 100 is integrated into the main computer C-P.

In a further embodiment, as an alternative to the preceding one and shown with dashed lines in FIG. 2a, the system 100 is external to the main computer C-P.

The system 100, as will be described below, comprises a plurality of modules, e.g., hardware modules or software logic, each configured to perform specific operations to detect anomalies in the radar system.

With particular reference to FIG. 3, the system 100 comprises a shipboard collector module 101 configured to receive, from the shipboard data communication network NTW with the support of a set video data transmission protocol, a stream of data packets F-P coming from the plurality of radar antenna units P-A distributed shipboard and configured to transmit data over said data communication network NTW.

The stream of data packets F-P can be transmitted over the data communication network NTW in multicast mode or broadcast mode.

Each data packet originating from a radar antenna unit A1, A2, . . . , AN of said plurality of radar antenna units P-A comprises an identification code I-D and technical values V-T representative of the radar antenna unit A1, A2, . . . , AN of said plurality of radar antenna units P-A from which such data packet originates, according to the video data transmission protocol employed on the data communication network NTW, e.g., the ASTERIX protocol.

The identification code I-D of a radar antenna unit A1, A2, . . . , AN is a unique code assigned to the radar antenna unit A1, A2, . . . , AN and represents the aggregation of multiple pieces of information, e.g., such as an antenna identification code (System Identification Code, SIC) of the radar antenna unit, a system area code (SAC) of the radar antenna unit, a data source IP address, a data destination IP address, and a network port number employed to communicate with the at least one display unit D-P of the radar system R-D.

The technical values V-T representative of the radar antenna unit can be found in the header of the data packet provided by the employed video data transmission protocol.

Examples of technical values V-T representative of the radar antenna unit are the rotation angle of the radar antenna unit, the video resolution in bits of the radar antenna unit, the azimuth and longitudinal resolution of the radar antenna unit, the type of video block, and the deviation of the radial track T-R relative to the center of the map (“center bias”).

Again referring to FIG. 3, the shipboard collector module 101 comprises an analyzer sub-module 102, an aggregator sub-module 103, a history sub-module 104 and a first database sub-module 105.

These sub-modules of the collector module 101 will be described below.

The analyzer sub-module 102, e.g., a hardware module or software logic, is configured to analyze each received data packet to extract the identification code I-D and said technical values V-T representative of the radar antenna unit A1, A2, . . . , AN of said plurality of radar antenna units P-A from which said data packet originates and to provide said identification code I-D and said technical values V-T representative of the radar antenna unit A1, A2, . . . , AN to a memory buffer (not shown in the figures) of said aggregator sub-module 103.

The aggregator sub-module 103, e.g., a hardware module or software logic, is configured to determine aggregate information I-A of the received data packet based on the identification code I-D and technical values V-T representative of the radar antenna unit extracted from the received data packet and based on additional technical values V-T′ representative of the radar antenna unit of said plurality of radar antenna units P-A identified by the same identification code I-D and previously stored in the memory buffer of the aggregator sub-module 103.

Determining aggregate information means, for example, calculating the mean, variance, mode or norm, or frequency distribution of the aforesaid technical values.

It is worth noting that the determination of aggregate information for a radar antenna unit occurs with each revolution of the radar antenna unit.

Furthermore, the analyzer sub-module 103 is configured to determine for each received data packet, a characterization F-G of said received data packet comprising the identification code I-D and the technical values V-T representative of the radar antenna unit extracted from the received data packet, the aggregate information I-A determined by the aggregator sub-module 103 and an aggregate information time series S-T associated with said radar antenna unit A1, A2, . . . , AN.

For example, the characterization F-G is a tuple thus comprising the aforesaid information.

The analyzer sub-module 103 is further configured to store the determined characterization F-G of the data packet received in the first database sub-module 105 of the shipboard collector module 101.

Instead, the analyzer sub-module 104 is configured to determine said aggregate information time series S-T contained in the characterization F-G of the data package received based on the aggregate information time series S-T′ previously stored in the first database sub-module 105 of the shipboard collector module 101 and associated with previously received data packets referred to the same radar antenna unit of said plurality of radio antenna units P-A.

For example, the aggregate information time series S-T contained in the characterization F-G of the received data packet is determined based on N aggregate information time series S-T′ previously stored in the first database sub-module 105 of the shipboard collector module 101, where N is an integer set a priori based on the computational capabilities of the system 100 in which the shipboard collector module 101 is installed.

Returning to FIG. 3, the system 100 further comprises a policy generator module 106 and a policy evaluation module 107, e.g., also hardware modules or software logic, described below.

In this regard, the shipboard collector module 101 is configured to provide the characterization F-G of the received data packet determined in the policy evaluation module 107. Furthermore, the shipboard collector module 101 is configured to provide a last characterization F-G′ determined for each received data packet referred to a radar antenna unit A1, A2, . . . , AN of said plurality of radar antenna units P-A other than the radar antenna unit A1, A2, . . . , AN from which the received data packet originated, to the policy generator module 106.

The policy generator module 106 is configured to select applicable set reference policies P-F based on the last characterization F-G′ determined for each received data packet referred to a radar antenna unit A1, A2, . . . , AN of said plurality of radar antenna units P-A other than the radar antenna unit A1, A2, . . . , AN from which the received data packet provided by the collector module 101 originates.

The applicable set reference policies P-F are selectable, by the policy generator module 106, from a plurality of candidate set reference policies P-F′ stored in a second database sub-module 106′ of the policy generator module 106.

Each reference policy P-F comprises set rules representative of the expected conditions of a radar system when working correctly. This also means that the performance of the radar system must conform to set standards and set regulations, e.g., such as those required by the International Maritime Organization (IMO).

Indeed, the operation of a radar system strictly follows the manufacturer's specifications, e.g., video resolution or speed of antenna units, and depends on onboard configurations, e.g., SIC/SAC or IP addresses, which do not change over time.

Consequently, a list of rules constraining standards and regulations, manufacturer specifications, and shipboard configurations can determine the expected behavior of a radar system.

The aforesaid reference policies can be expressed on values, their calculated aggregations, e.g., mean, mode or norm, or variance, or frequency distribution obtained from the information carried by the data packets according to the video data transmission protocol, e.g., ASTERIX.

A reference policy contains conditions which specify its suitability for the radar system under monitoring and uses variables to reference quantities which depend on individual manufacturers or shipboard configurations.

According to the present invention, the system 100 can automatically infer the suitability of candidate reference policies and the values of their variables after having received an adequate amount of video data traffic according to the set video data transmission protocol, e.g., ASTERIX.

Examples of reference policies are a set angle of rotation, a set scanning angle, a set scanning speed, a set maximum distance covered, set obscured sectors (i.e., sectors wherein systematically no video data transmission is made), a set “center bias”, a set azimuth and longitudinal resolution, a set number of bits, a set number of antenna units, and so on.

The policy generator module 106 is configured to provide the aforesaid selected applicable set reference P-F to a third database sub-module 107′ of said policy evaluation module 107.

The policy evaluation module 107 is configured to detect the presence or absence of an anomaly in the radar system based on the comparison of the characterization F-G of the received data packet provided by the shipboard collector module 101 and the selected applicable set reference policies stored in the third sub-module database 107′ of said policy evaluation module 107.

For example, a transmission of false video data in a radar antenna unit A1, A2, . . . , AN, inserted into the radar system by a computer attack, can result in a change in the set rotational speed, thus the scanning speed, of said radar antenna unit A1, A2, . . . , AN.

Therefore, if it is detected that a rotating radar antenna unit is rotating at a non-constant speed, contrary to a set reference policy, the policy evaluation module 107 is configured to detect the presence of an anomaly in the radar system.

Returning to the policy evaluation module 107, it is configured to generate information I1 representative of an anomaly detected in the radar system R-D.

In an embodiment, the collector module 101 comprises an anomaly receiver sub-module 108, e.g., a hardware module or software logic.

In this embodiment, the policy evaluation module 107 is configured to provide the information I1 representative of an anomaly detected in the radar system R-D to the anomaly receiver sub-module 108.

The anomaly receiver sub-module 108 is configured to display, by means of a software application, the information I1 representative of an anomaly detected in the radar system R-D.

For example, the software application can be a WEB application, a native application, a Windows or Linux application, and so on.

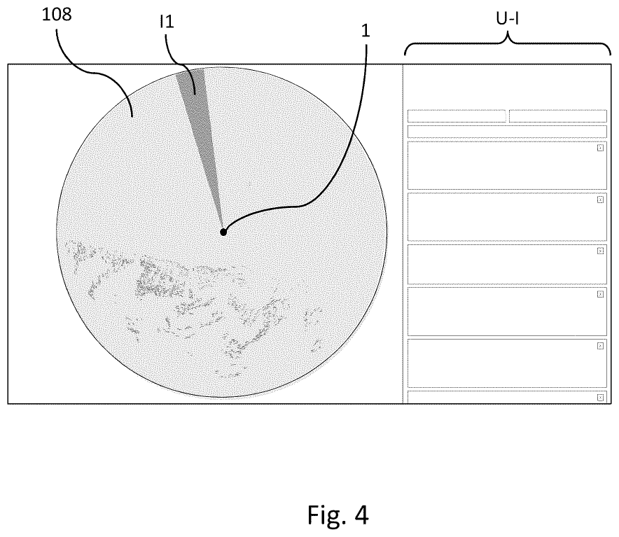

For example, as shown in FIG. 4, the information I1 representative of an anomaly detected in the radar system R-D is a sector of a circular scan plane such as the one provided in the at least one display unit D-P by the radar system R-D.

In an embodiment, in combination with the preceding one and shown in FIG. 4, the anomaly receiver sub-module 108 is configured to display, by means of the software application, additional technical information U-I representative of the detected anomaly besides the information I1 representative of a detected anomaly in the radar system R-D.

Additional technical information U-I comprises, for example, the policy which was breached and what function within the radar system triggered the breach.

In a further embodiment, in combination with any one of the above, the policy evaluation module 107 is configured to associate the information I1 representative of an anomaly detected in the radar system R-D with an anomaly destination IP address.

In this embodiment, the policy evaluation module 107 is configured to transmit the information I1 representative of an anomaly detected in the radar system R-D to a destination corresponding to the anomaly destination IP address associated with the information I1 representative of an anomaly detected in the radar system R-D.

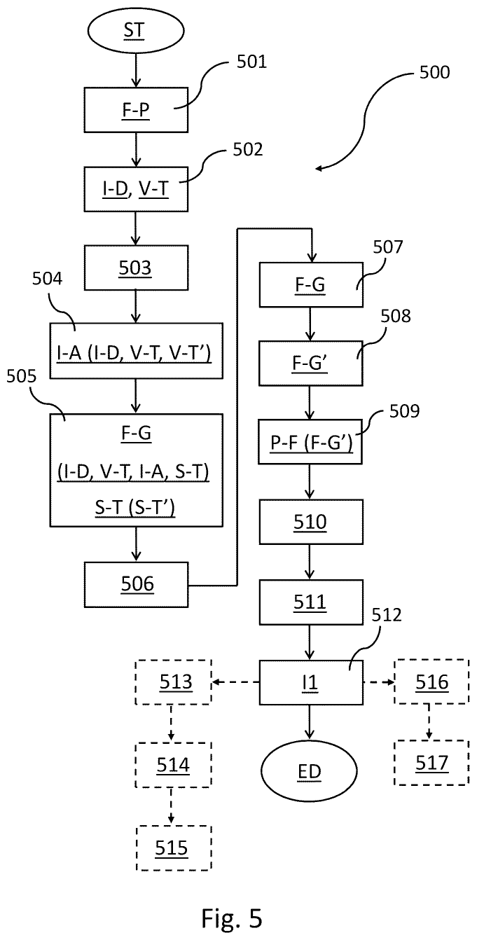

With reference now also to the block diagram in FIG. 5, a method 500 for detecting anomalies in a radar system R-D on board of a ship, hereinafter also detection method or simply method.

The radar system R-D was described above.

Furthermore, it is worth noting that the components and information mentioned below with the description of the method were described previously with reference to the system 100 and will therefore not be repeated for the sake of brevity.

The method 500 comprises a symbolic step of starting ST.

The method 500 comprises a step of receiving 501, by a shipboard collector module 101, from a shipboard data communication network NTW with the support of a set video data transmission protocol, a stream of data packets F-P from a plurality of radio antenna units P-A distributed shipboard and configured to transmit data over said data communication network NTW.

Each data packet originating from a radar antenna unit A1, A2, . . . , AN of said plurality of radar antenna units P-A comprises an identification code I-D and technical values V-T representative of the radar antenna unit A1, A2, . . . , AN of said plurality of radar antenna units P-A from which such data packet originates, according to the video data transmission protocol employed on the data communication network NTW, e.g., the ASTERIX protocol.

The identification code I-D of a radar antenna unit and representative of the technical values V-T of the radar antenna unit were described before, with some examples.

The method 500 further comprises a step of analyzing 502, by an analyzer sub-module 102 of the shipboard collector module 101, each received data packet to extract the identification code I-D and said technical values V-T representative of the radar antenna unit A1, A2, . . . , AN of said plurality of radar antennas P-A from which said data packet originates, and providing 503, by an analyzer sub-module 102 of the shipboard collector module 101, said identification code I-D and said technical values V-T representative of the radar antenna unit A1, A2, . . . , AN to a memory buffer (not shown in the figures) of an aggregator sub-module 103 of the shipboard collector module 101.

The method 500 further comprises a step of determining 504, by the aggregator sub-module 103 of the shipboard collector module 101, aggregate information I-A of the received data packet based on the identification code I-D and the technical values V-T representative of the radar antenna unit A1, A2, . . . , AN extracted from the received data packet and based on additional technical values V-T′ representative of the radar antenna unit A1, A2, . . . , AN of said plurality of radar antenna units P-A identified by the same identification code I-D and previously stored in the memory buffer of the aggregator sub-module 103 of the shipboard collector module 101.

The definition of determining aggregate information was defined above.

The method 500 further comprises a step of determining 505, by the analyzer sub-module 102 of the shipboard collector module 101, for each received data packet, a characterization F-G of said received data packet comprising the identification code I-D and the technical values V-T representative of the radar antenna unit A1, A2, . . . , AN extracted from the received data packet, the aggregate information I-A determined by the aggregator sub-module 103 and an aggregate information time series S-T associated with said radar antenna unit A1, A2, . . . , AN.

As mentioned earlier, the characterization F-G is, for example, a tuple thus comprising the aforesaid information.

The method 500 further comprises a step of storing 506, by the analyzer sub-module 102 of the shipboard collector module 101, the determined characterization F-G of the data packet received in a first database sub-module 105 of the shipboard collector module 101.

The aggregate information time series S-T contained in the characterization F-G of the received data packet is determined, by a history sub-module 104 of the shipboard collector module 101, based on aggregate information time series S-T′ previously stored in the first database sub-module 105 of the shipboard collector module 101 and associated with previously received data packets referring to the same radar antenna unit of said plurality of radar antenna units P-A.

An example of determining the aggregate information time series S-T contained in the characterization F-G of the received data packet was given earlier.

The method 500 further comprises a step of providing 507, by the shipboard collector module 101, the determined characterization F-G of the received data packet 101 to a policy evaluation module 107.

Furthermore, the method 500 comprises a step of providing 508, by the shipboard collector module 101, a last characterization F-G′ determined for each received data packet referred to an antenna unit of said plurality of radar antenna units P-A other than the radar antenna unit from which the received data packet originates, to a policy generator module 106.

The method 500 comprises a step of selecting 509, by the policy generator module 106, applicable set reference policies P-F based on a last characterization F-G′ determined for each received data packet referred to a radar antenna unit of said plurality of radar antenna units P-A other than the radar antenna unit from which the received data packet originates provided by the shipboard collector module 101.

The applicable set reference policies P-F are selectable from a plurality of candidate set reference policies P-F′ stored in a second database sub-module 106′ of the policy generator module 106.

As mentioned above, each reference policy P-F comprises set rules representative of the expected conditions of a radar system when working correctly.

Examples of the reference policy were provided above.

The method 500 further comprises a step of providing 510, by the policy generator module 106, said selected applicable set reference policies P-F to a third database sub-module 107′ of said policy evaluation module 107.

The method 500 further comprises a step of detecting 511, by the policy evaluation module 107, the presence or absence of an anomaly in the radar system based on the comparison between the characterization F-G of the received data packet provided by the shipboard collector module 101 and the selected applicable set reference policies P-F stored in the third database sub-module 107′ of said policy evaluation module 107.

The method 500 further comprises a step of generating 512, by the policy evaluation module 107, information I1 of an anomaly detected in the radar system R-D.

The method further comprises a symbolic step of ending ED.

In an embodiment, shown with dashed lines in FIG. 5, wherein the shipboard collector module 101 comprises an anomaly receiver sub-module 108, e.g., a hardware module or software logic, the method 500 comprises a step of providing 513, by the policy evaluation module 107, the information I1 representative of an anomaly detected in the radar system R-D to the anomaly receiver sub-module 108 of the shipboard collector module 101.

In this embodiment, the method 500 further comprises a step of displaying 514, by the anomaly receiver sub-module 108, by means of a software application, the information I1 representative of an anomaly detected in the radar system R-D.

Examples of software application were indicated above.

For example, as shown in FIG. 4, the information I1 representative of an anomaly detected in the radar system R-D is a sector of a circular scan plane such as the one provided in the at least one display unit D-P by the radar system R-D.

In an embodiment, in combination with the preceding one and shown with dashed lines in FIG. 5, the method 500 comprises a step of displaying 515, by the anomaly receiver sub-module 108 by means of the software application, additional technical information U-I representative of the detected anomaly besides the information I1 representative of a detected anomaly in the radar system R-D.

Additional technical information U-I comprises, for example, the policy which was breached and what function within the radar system triggered the breach.

In a further embodiment, in combination with any one of the above and shown with dashed lines in FIG. 5, the method 500 further comprises a step of associating 516, by the policy evaluation module 107, an anomaly destination IP address with the information I1 representative of an anomaly detected in the radar system R-D.

In this embodiment, the method further comprises a step of transmitting 517, by the policy evaluation module 107, the information I1 representative of an anomaly detected in the radar system R-D to a destination corresponding to the anomaly destination IP address associated with the information I1 representative of an anomaly detected in the radar system R-D.

It is worth noting that the object of the present invention is fully achieved.

Firstly, the method and related system for detecting anomalies in the radar system of a ship monitors the data navigation network which detects similar and unknown attacks against the radar system and operates without requiring changes to the existing shipboard integrated navigation system (INS) configuration.

Indeed, it can automatically adapt to any configuration of the ship.

Furthermore, the method and related system according to the present invention can detect all the attacks which aim at breaching the normal operation of a radar system because it models the expected behavior in any running configuration.

Furthermore, the method and related system covered by the present invention operates by connecting to the bridge data communication network and listening to multicast video data traffic like other equipment in the integrated navigation system (INS).

Therefore, the implementation of the method and related system according to the present invention does not require redesign, standardization and certification of the systems already shipboard.

Again, the method and related system covered by the present invention enables the detection of attacks on the data navigation network with high accuracy and at a minimal resource footprint.

Finally, it is worth noting that the detection operates only on the data packet header provided by the video data transmission protocol and can guarantee similar performance on other types of antenna units, even at higher video resolutions.

The method and related system covered by the present invention can recognize attacks with a high level of accuracy.

The distinguishing features of this method and related system are self-adaptation to each onboard configuration, modeling the normative and expected behavior to identify known and unknown attacks, the possibility of monitoring without altering the onboard systems, and minimal resource footprint.

A person skilled in the art may make changes and adaptations to the embodiment of the method and respective system described above or can replace elements with others which are functionally equivalent to satisfy contingent needs without departing from the scope of protection of the appended claims. All the features described above as belonging to one possible embodiment may be implemented independently from the other described embodiments.

1. A method for detecting anomalies in a radar system on board of a ship, comprising steps of:
receiving, by a shipboard collector module, from a shipboard data communication network with support of a set video data transmission protocol, a stream of data packets coming from a plurality of radar antenna units distributed shipboard and configured to transmit data on said data communication network, each data packet originating from a radar antenna unit of said plurality of radar antenna units, and comprising an identification code and technical values representative of the radar antenna unit of said plurality of antennas from which said data packet originates;
analyzing, by an analyzer sub-module of the shipboard collector module each received data packet to extract the identification code and said technical values representative of the radar antenna unit of said plurality of antennas from which said data packet originates and providing said identification code and said technical values representative of the radar antenna unit to a memory buffer of an aggregator sub-module of the shipboard collector module;
determining, by the aggregator sub-module of the shipboard collector module, aggregate information of the received data packet based on the identification code and technical values representative of the radar antenna unit extracted from the received data packet and based on additional technical values representative of the radar antenna unit of said plurality of radar antenna units identified by the identification code and previously stored in the memory buffer of the aggregator sub-module of the shipboard collector module;
determining, by the analyzer sub-module of the shipboard collector module, for each received data packet, a characterization of said received data packet comprising the identification code and the technical values representative of the radar antenna unit extracted from the received data packet, the aggregate information determined by the aggregator sub-module and an aggregate information time series associated with said radar antenna unit;
storing, by the analyzer sub-module of the shipboard collector module, the determined characterization of the received data packet in a first database sub-module of the shipboard collector module, said aggregate information time series contained in the characterization of the received data packet being determined, by a historical sub-module of the shipboard collector module, based on aggregate information time series previously stored in the first database sub-module of the shipboard collector module and associated with previously received data packets referring to the same radar antenna unit of said plurality of radio antenna units;
providing by the shipboard collector module the determined characterization of the received data packet to a policy evaluation module;
providing by the shipboard collector module, a last characterization determined for each received data packet referred to a radar antenna unit of said plurality of radar antenna units other than the radar antenna unit from which the received data packet originates, to a policy generator module;
selecting by the policy generator module, set reference policies applicable based on the last characterization determined for each received data packet referred to a radar antenna unit of said plurality of radar antenna units other than the radar antenna unit from which the received data packet originates provided by the shipboard collector module said applicable set reference policies being selected from a plurality of candidate set reference policies stored in a second database of the policy generator module, each reference policy comprising set rules representative of the expected conditions of the radar system when operating correctly;
providing, by the policy generator module, said selected applicable set reference policies to a third database sub-module of said policy evaluation module;
detecting, by the policy evaluation module, the presence or absence of an anomaly in the radar system based on s comparison between the characterization of the received data packet provided by the shipboard collector module and the selected applicable set reference policies stored in the third database sub-module of said policy evaluation module;
generating by the policy evaluation module, information representative of an anomaly detected in the radar system.

2. The method according to claim 1, wherein the collector module comprises an anomaly receiver sub-module, the method comprising a step of providing, by the policy evaluation module, the information representative of an anomaly detected in the radar system to the anomaly receiver sub-module of the shipboard collector module.

3. The method according to claim 1, further comprising a step of displaying, by the anomaly receiver sub-module, by a software application, the information representative of an anomaly detected in the radar system.

4. The method according to claim 3, comprising a step of displaying, by the anomaly receiver sub-module, by the software application, additional technical information representative of the detected anomaly besides the information representative of a detected anomaly in the radar system.

5. The method according to claim 1, further comprising a step of associating, by the policy evaluation module, an anomaly destination IP address with the information representative of an anomaly detected in the radar system.

6. The method according to claim 5, further comprising a step of transmitting, by the policy evaluation module, the information representative of an anomaly detected in the radar system to a destination corresponding to the anomaly destination IP address associated with the information representative of an anomaly detected in the radar system.

7. An anomaly detection system in a radar system on board of a ship, comprising:
a shipboard collector module configured to receive from a shipboard data communication network with the support of a set video data transmission protocol, a stream of data packets coming from a plurality of radar antenna units distributed shipboard and configured to transmit data on said data communication network, each data packet originating from a radar antenna unit of said plurality of radar antenna units, and comprising an identification code and the technical values representative of the radar antenna unit of said plurality of antennas from which said data packet originates,
said shipboard collector module comprising:
an analyzer sub-module;
an aggregator sub-module;
a historical sub-module;
a first database sub-module;
said analyzer sub-module being configured to analyze each received data packet to extract the identification code and said technical values representative of the radar antenna unit of said plurality of radar antenna units from which said data packet originates and to provide said identification code and said technical values representative of the radar antenna unit to a memory buffer of said aggregator sub-module,
the aggregator sub-module being configured to determine aggregate information of the received data packet based on the identification code and the technical values representative of the radar antenna unit extracted from the received data packet and based on additional technical values representative of the radar antenna unit of said plurality of radar antenna units identified by the identification code and previously stored in the memory buffer of the aggregator sub-module,
the analyzer sub-module being configured to determine for each received data packet, a characterization of said received data packet comprising the identification code and technical values representative of the radar antenna unit extracted from the received data packet, the aggregate information determined by the aggregator sub-module and an aggregate information time series associated with said radar antenna unit,
the analyzer sub-module being configured to store the determined characterization of the received data packet in a first database sub-module of the shipboard collector module the historical sub-module being configured to determine said aggregate information time series contained in the characterization of the data package received based aggregate information time series previously stored in the first database sub-module of the shipboard collector module and associated with previously received data packets referred to the radar antenna unit of said plurality of radio antenna units,
the system further comprises a policy generator module and a policy evaluation module,
the shipboard collector module being configured to provide the determined characterization of the received data packet to the policy evaluation module
the shipboard collector module being configured to provide a last determined characterization for each received data packet referred to a radar antenna unit of said plurality of radar antenna units other than the radar antenna unit from which the received data packet originates, to the policy generator module,
the policy generator module being configured to select applicable set reference policies based on the last characterization determined for each received data packet referred to a radar antenna unit of said plurality of radar antenna units other than the radar antenna unit from which the received data packet provided by the collector module originates, said applicable set reference policies being selectable from a plurality of candidate set reference policies stored in a second database sub-module of the policy generator module each reference policy comprising set rules representative of expected conditions of a radar system when correctly operated,
the policy generator module being configured to provide said selected applicable set reference policies to a third database sub-module of said policy evaluation module,
the policy evaluation module being configured to detect the presence or absence of an anomaly in the radar system based on a comparison between the characterization of the received data packet provided by the shipboard collector module and the selected applicable set reference policies stored in the third database sub-module of said policy evaluation module,
the policy evaluation module being configured to generate information representative of an anomaly detected in the radar system.

8. The system according to claim 7, wherein the collector module comprises an anomaly receiver sub-module, the policy evaluation module being configured to provide the information representative of an anomaly detected in the radar system to the anomaly receiver sub-module.

9. The system according to claim 8, wherein the anomaly receiver sub-module is configured to display, by a software application, the information representative of an anomaly detected in the radar system.

10. The system according to claim 9, wherein the anomaly receiver sub-module is configured to display, by the software application, additional technical information representative of the detected anomaly besides the information representative of a detected anomaly in the radar system.

11. The system according to claim 7, wherein the policy evaluation module is configured to associate the information representative of an anomaly detected in the radar system with an anomaly destination IP address.

12. The system according to claim 11, wherein the policy evaluation module is configured to transmit the information representative of an anomaly detected in the radar system to a destination corresponding to the anomaly destination IP address associated with the information representative of an anomaly detected in the radar system.
